(19) United States
(12) Patent Application Publication
(10) Pub. No.: US 2015/0011257 A1
(43) Pub. Date: Jan. 8, 2015

(54) Smartphone Handle

(71) Applicants: Yen-Wei Hsu, Taipei (TW); Whei-Chyou Wu, Fremont, CA (US)

(72) Inventors: Yen-Wei Hsu, Taipei (TW); Whei-Chyou Wu, Fremont, CA (US)

(21) Appl. No.: 13/936,216

(22) Filed: Jul. 8, 2013

(51) Int. Cl. H04M 1/725; H04M 1/02

(52) U.S. Cl. CPC H04M 1/72563; H04M 1/0254
USPC 455/556.1; 455/575.1

(57) ABSTRACT

The invention relates to a smartphone, and more particularly, relates to user more conveniently and firmly hold a smartphone and more quickly to respond to take a picture and shoot a video.

### BACKGROUND OF THE INVENTION

1. Field of the Invention

The invention relates to a smartphone, and more particularly, relates to user more conveniently and firmly hold a smartphone and more quickly to respond to take a picture and shoot a video.

2. Description of Related Art

The smartphone is more popular by everybody. The smartphone has featured very sensitive touchscreen for receiving finger input and built-in camera and video capability operated by finger on the touchscreen. The touchscreen has brought user different ways to operate the smartphone compared to conventional mobile phone. The compact and small size of smartphone are also pursued by the manufacturer. Small size smartphone and high sensitive touchscreen easily make user easier mistouch on the touchscreen and more difficult precisely operate the tiny icons on the high sensitive touchscreen especially for taking a sudden picture or shooting a sudden video film. For example, for a suddenly come-out scene, user has to respond very quickly to find the camera icon and then precisely touch the found icon to get the smartphone into the camera and video mode with the appearance of some associated camera/video icons, and then user has to focus on the right icons against mistouching the others and try to aim to capture the transient scene at the same time. The result is that user usually fails to capture the transient scene.

Hand including fingers is usually bigger than or matches to the smartphone in size. Only skilled people can hold and operate a smartphone by using only one hand. For the most people usually have to use two hands to operate the smartphone with one hand holding the smartphone and finger of the other hand touching the icons. Due to limited size of the smartphone with a very sensitive touchscreen, the fingers of the hand holding the smartphone easily make mistakenly touch the sensitive touchscreen, the fingers of the hand holding the smartphone can potentially obstruct user's view of the touchscreen, the hand holding the smartphone with its fingers can potentially obstruct the lens, speaker, and flash light usually disposed on the rear housing of the smartphone, and finger of the other hand aiming to operate the icons so that user has to be very careful and pay a lot attention in fingers and the way of the hand holding the smartphone when operating the smartphone. The burdened attention on fingers and the way of holding the smartphone can distract user's attention on operating the smartphone and potentially keep user against firmly holding the smartphone. The problems get even more troublesome when the user in a situation has only a little time to respond or the user in a situation has to respond as quickly as possible, for example, the user responds to take a sudden picture or shoot a sudden video.

Aiming at those drawbacks, the present invention has provided solutions to solve the problems.

### BRIEF SUMMARY OF THE INVENTION

A first object of the present invention is to let user be able to more firmly and conveniently hold the smartphone and let user more conveniently operate the smartphone with lower chances of mistouch on the touchscreen of the smartphone.

A second object of the present invention is to let user be able to easier use only one hand to take a picture or shoot a video film.

A third object of the present invention is to let user be able to more quickly respond to take a transient picture or shoot a transient video film.

### BRIEF DESCRIPTION OF THE SEVERAL VIEWS OF THE DRAWINGS

FIG. 1(a) has shown an embodiment of a smartphone protective case and a handle in 3-dimension;

FIG. 1(b) has shown the smartphone protective case of FIG. 1(a) and a handle cover for storaging the handle of FIG. 1(a) fixed with the smartphone protective case;

FIG. 1(c) is a front view of FIG. 1(b) with the handle inserted into the handle cover;

FIG. 2(a) has shown a smartphone is disposed in the smartphone protective case of FIG. 1(a) with the handle fixed with the smartphone protective case;

FIG. 2(b) has shown a smartphone is disposed in the smartphone protective case of FIG. 1(b) with the handle fixed with the smartphone protective case;

FIG. 2(c) is a front view of FIG. 2(b);

FIG. 3(a) has shown a flow chart in a smartphone when a sensor is triggered and sensed by a controller of the smartphone;

FIG. 3(b) has shown a switch in an open state;

FIG. 3(c) has shown the switch of FIG. 3(b) in short state when the switch is pressed by a body;

FIG. 4(a) has shown an embodiment of a housing of a smartphone in and a handle in 3-dimension;

FIG. 4(b) has shown the housing of the smartphone of FIG. 4(a) and a handle cover for storaging the handle of FIG. 4(a) fixed with the housing of the smartphone;

FIG. 4(c) is a front view of FIG. 4(b) with the handle inserted into the handle cover;

FIG. 5(a) has shown FIG. 4(a) with the handle fixed with the housing of the smartphone;

FIG. 5(b) has shown FIG. 4(b) with the handle fixed with the housing of the smartphone;

FIG. 5(c) is a front view of FIG. 5(b);

FIG. 6(a) has shown an embodiment of a front view of a smartphone protective case having a space formed in the smartphone protective case for storaging a handle;

FIG. 6(b) is a side view of the smartphone protective case of FIG. 6(a);

FIG. 6(c) is a top view of the smartphone protective case of FIG. 6(a);

FIG. 6(d) is FIG. 6(a) with the handle taken out of the space and fixed with the smartphone protective case;

FIG. 7(a) has shown an embodiment of a front view of a housing of a smartphone having a space formed in the smartphone protective case for storaging a handle;

FIG. 7(b) is a side view of the housing of the smartphone of FIG. 7(a);

FIG. 7(c) is a top view of the housing of the smartphone of FIG. 7(a);

FIG. 7(d) is FIG. 7(a) with the handle taken out of the space and fixed with the housing of the smartphone;

FIG. 8(a) has shown an embodiment of a smartphone protective case in 3-dimension and a handle disposed inside the smartphone protective case;

FIG. 8(b) is a side view of the smartphone protective case of FIG. 8(a);

FIG. 8(c) is FIG. 8(b) with the handle pulled or slided out;

FIG. 8(d) is a back view of the smartphone protective case of

FIG. 8(a);

FIG. 8(e) is FIG. 8(d) with the handle pulled or slided out;

FIG. 9(a) has shown an embodiment of a housing of a smartphone in 3-dimension and a handle disposed inside the housing;

FIG. 9(b) is a side view of the housing of the smartphone of FIG. 9(a);

FIG. 9(c) is FIG. 9(b) with the handle pulled or slided out;

FIG. 9(d) is a back view of the housing of the smartphone of

FIG. 9(a);

FIG. 9(e) is FIG. 9(d) with the handle pulled or slided out;

FIG. 10(a) has shown an embodiment of a front view of a back of a smartphone protective case or a housing of a smartphone with a handle installed at its back;

FIG. 10(b) is a side view of FIG. 10(a);

FIG. 10(c) is a top view of FIG. 10(a);

FIG. 10(d) is FIG. 10(a) with the handle slided out of the edge of the smartphone protective case or the housing of the smartphone;

FIG. 11(a) is FIG. 10(a) with a sliding-spring element installed;

FIG. 11(b) is a side view of FIG. 11(a);

FIG. 11(c) is a top view of FIG. 11(a);

FIG. 12 is a front view of the smartphone of FIG. 10(a) and FIG. 11(a) with the handle slided out;

FIG. 13(a) has shown an embodiment of a handle connected to a rotational element fixed on the back of a smartphone protective case;

FIG. 13(b) is a side view of the embodiment of FIG. 13(a);

FIG. 13(c) is a back view of the embodiment of FIG. 13(a);

FIG. 13(d) is FIG. 13(c) with the handle rotated out to be held by hand;

FIG. 14(a) has shown an embodiment of a handle connected to a rotational element fixed on the back of a housing of a smartphone;

FIG. 14(b) is a side view of the embodiment of FIG. 14(a);

FIG. 14(c) is a back view of the embodiment of FIG. 14(a);

FIG. 14(d) is FIG. 14(c) with the handle rotated out to be held by hand;

FIG. 15 is a front view of FIG. 14(d);

FIG. 16(a) has shown an embodiment of a handle connected to a rotational element fixed on the back of a smartphone protective case;

FIG. 16(b) is a side view of the embodiment of FIG. 16(a);

FIG. 16(c) is a back view of the embodiment of FIG. 16(a);

FIG. 16(d) is FIG. 16(c) with the handle rotated out;

FIG. 17(a) has shown an embodiment of a handle connected to a rotational element fixed on the back of a housing of a smartphone;

FIG. 17(b) is a side view of the embodiment of FIG. 17(a);

FIG. 17(c) is a back view of the embodiment of FIG. 17(a);

FIG. 17(d) is FIG. 17(c) with the handle rotated out;

FIG. 18(a) has shown an embodiment of a handle disposed inside a smartphone protective case and connected to a rotational element fixed with the smartphone protective case;

FIG. 18(b) is a side view of the embodiment of FIG. 18(a);

FIG. 18(c) is a back view of the embodiment of FIG. 18(a);

FIG. 18(d) is FIG. 18(c) with the handle rotated out;

FIG. 19(a) has shown an embodiment of a handle disposed inside a housing of a smartphone and connected to a rotational element fixed with the housing;

FIG. 19(b) is a side view of the embodiment of FIG. 19(a);

FIG. 19(c) is a back view of the embodiment of FIG. 19(a);

FIG. 19(d) is FIG. 19(c) with the handle rotated out;

FIG. 20 is a front view respectively of the smartphone of FIG. 17(d) and FIG. 19(d) with a plurality of camera and/or video associated icons and/or a plurality of routine function keys shown on a touchscreen of the smartphone touchable by the thumb of hand holding the handle.

FIG. 21(a) has shown a smartphone protective case and a handle in 3-dimension;

FIG. 21(b) has shown the smartphone protective case and the handle of FIG. 21(a) with the handle held by a clamp fixed to the smartphone protective case;

FIG. 22(a) has shown a housing of a smartphone and a handle in 3-dimension view;

FIG. 22(b) has shown the housing of the smartphone of FIG. 22(a) and the handle is held by a clamp fixed to the housing of the smartphone;

FIG. 23(a) has shown a smartphone protective case, a handle, and a handle container fixed to the rear smartphone protective case in 3-dimension;

FIG. 23(b) is a side view of FIG. 23(b);

FIG. 23(c) is FIG. 23(b) with the handle slided out of the handle container;

FIG. 23(d) is a back view of FIG. 23(a);

FIG. 23(e) is FIG. 23(d) with the handle slided out of the handle container;

FIG. 24(a) has shown a housing of a smartphone, a handle, and a handle container fixed to the back of the housing in 3-dimension;

FIG. 24(b) is a side view of FIG. 24(b);

FIG. 24(c) is FIG. 24(b) with the handle slided out of the handle container;

FIG. 24(d) is a back view of FIG. 24(a);

FIG. 24(e) is FIG. 24(d) with the handle slided out of the handle container; and

FIG. 25 is FIG. 15 with the smartphone disposed in horizontal position to take a picture or shoot a video film.

### DETAILED DESCRIPTION OF THE INVENTION

Smartphone protective case is known for a case covering a smartphone for protecting the smartphone.

FIG. 1(a) has shown an inventive smartphone protective case 101 in 3-dimension view trying to be in a general form with some openings 1015 on the smartphone protective case 101. Those openings are for exposing button switches, cam era lens, flash light, speaker, mic, power connector, and I/O port of a smartphone disposed in the smartphone protective case 101. For the simplicity of the drawing, those openings will not shown in the later drawings in the invention.

The smartphone protective case 101 has a first connector 1011 and a handle 102 with a suitable size and shape for being comfortably and firmly held by hand has a second connector 1021. The first connector 1011 and the second connector 1021 couple together for fixing the handle 102 with the smartphone protective case 101.

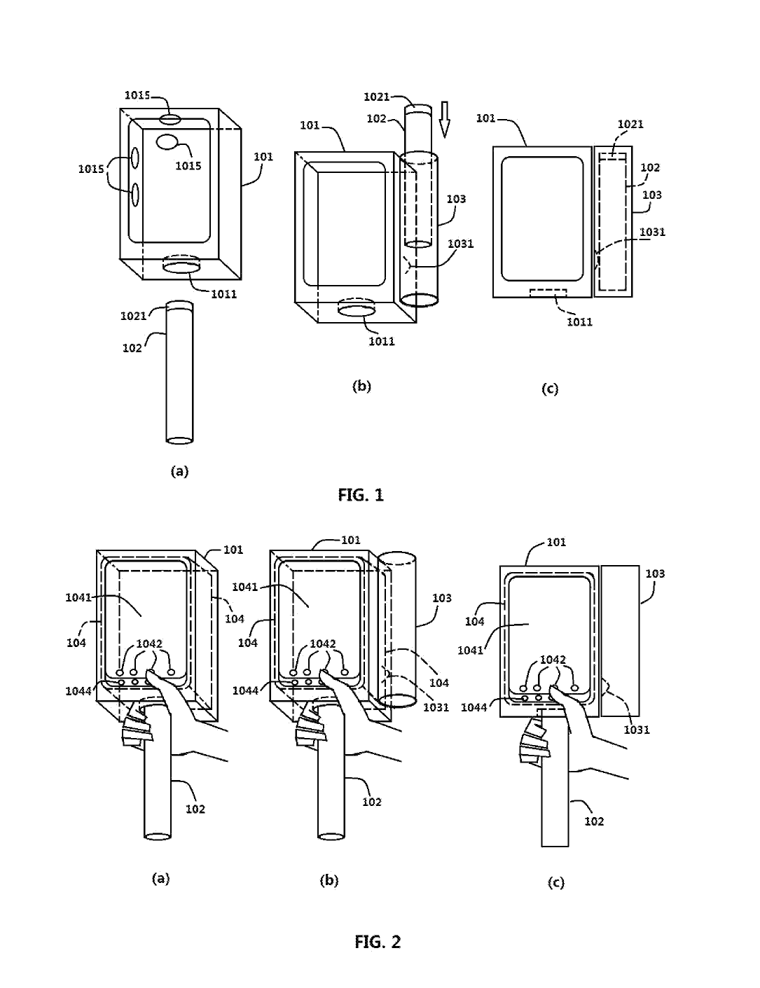

A smartphone 104 is disposed in the smartphone protective case 101 with the coupling of the first connector 1011 and the second connector 1021 as shown in FIG. 2(a). The handle 102 has some advantages: (1) the handle 102 can be viewed as an extension of the smartphone protective case 101 providing more space for user to firmly and conveniently hold so that the hand of the user holding the handle can be kept a little bit away from the touchscreen to lower the chance of mistouching the touchscreen of the smartphone and leave more room for the other hand of the user to more conveniently and precisely operate the smartphone and (2) if the camera and video associated icons shown on the touchscreen of the smartphone 104 are reachable or touchable by the thumb of the hand holding the handle 102, then user can take a picture and shoot a video by using only one hand. Without the handle, when user is taking a picture or shoot a video, user has to use one hand to hold the smartphone and use the finger of the other hand to touch the camera and video associated icons shown on the touchscreen of the smartphone 104.

The coupling of the first connector 1011 and the second connector 1021 are for fixing the handle 102 with the smartphone protective case 101 and they are not limited to any particular connectors, for example, one of the first connector 1011 and the second connector 1021 can be a male screw and the other one of the first connector 1011 and the second connector 1021 can be a female screw, or the first connector 1011 is a cylindrical hole opened on the smartphone protective case 101 and the second connector 1021 is shaped as a cylinder, a little bit smaller than the cylindrical hole, inserting into the first connector 1011 to complete the coupling. The coupling of the first connector 1011 and the second connector 1021 can be separable.

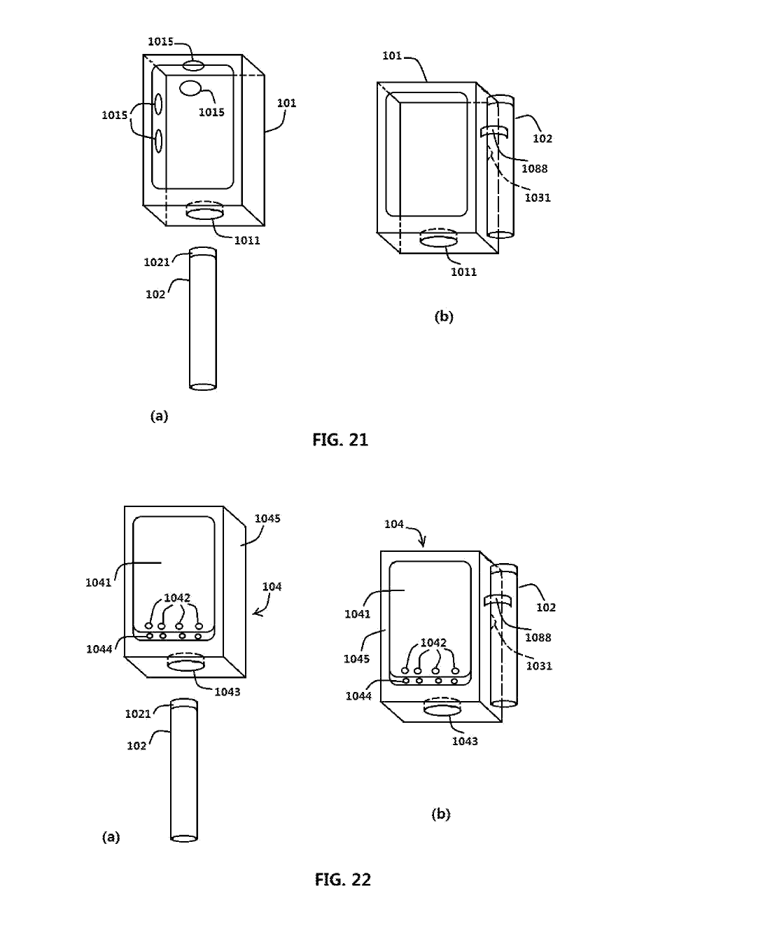

When the handle 102 is separated from the smartphone protective case 101, the handle 102 can be disposed into a space 1035 formed in the smartphone protective case 101 as shown an embodiment of FIG. 6, the handle 102 can be disposed into a handle container 103 fixed with the smartphone protective case 101 as shown an embodiment of FIG. 1(b), or the handle 102 can be held by a clamp 1088 fixed to the smartphone protective case 101 as shown an embodiment of FIG. 21(b). The handle container 103 is not located to any particular position on the smartphone protective case 101, for example, the embodiment of FIG. 1(b) has shown the handle container 103 fixed with a side of the smartphone protective case 101 although the present invention is not so limited. FIG. 1(c) is the front view of the embodiment of FIG. 1(b). The smartphone 104 is disposed in the smartphone protective case 101 of FIG. 1(b) with the coupling of the first connector 1011 and the second connector 1021 as shown in FIG. 2(b) and FIG. 2(c), which is the front view of FIG. 2(b). The clamp 1088 is not located to any particular position on the smartphone protective case 101, for example, the embodiment of FIG. 21(b) has shown the clamp 1088 fixed to a side of the smartphone protective case 101 although the present invention is not so limited.

FIG. 2 has shown a smartphone disposed into the smartphone protective case 101 of FIG. 1 with the handle 102 fixed on the smartphone protective case 101. FIG. 2 has shown a plurality of camera and/or video associated icons 1042 and/or a plurality of routine function keys 1044 on the touchscreen 1041 at a location touchable or reachable by the thumb of hand holding the handle 102 so the thumb can touch the icons to operate the icons.

The camera and/or video associated icons 1042 stand for any icons associated with camera and/or video functions. The camera and/or video associated icons are not limited to any particular camera and/or video associated icons, for example, the camera and/or video associated icon can be operated for switching between still picture and video modes, operated for switching between seeing front or seeing rear modes of lens, a shutter icon, operated for controlling flash light, an icon for photo or video editing, and an icon for photo file management, etc.

The first connector 1011 is not limited to any particular location on the smartphone protective case 101. If the first connector 1011 is located at a lower location such as the bottom of the smartphone protective case 101 as shown in FIG. 1 and FIG. 2, then the camera and/or video associated icons should be disposed at a lower location of the touchscreen touchable by the thumb of the hand holding the handle.

Due to the camera and/or video associated icons 1042 and/or the plurality of routine function keys 1044 are usually appeared at lower location on the touchscreen 1041 when the smartphone is in camera or video mode so the first connector 1011 can be located at a lower location such as the bottom of the smartphone protective case 101 as shown in FIG. 1 and FIG. 2 although the present invention is not so limited. The embodiments of FIG. 1 and FIG. 2 have also shown the handle is centered at the lower location of the smartphone protective case 101 although the present invention is not so limited.

As earlier stated, the handle 102 can be disposed into a space 1035 formed in the smartphone protective case 101 as shown in an embodiment of FIG. 6. FIG. 6(a), FIG. 6(b) and FIG. 6(c) are respectively a front view, a side view, and a top view of the smartphone protective case 101 having the space 1035. FIG. 6(d) is FIG. 6(a) with the handle 102 pulled or slided out of the space 1035 to be fixed with the smartphone protective case 101.

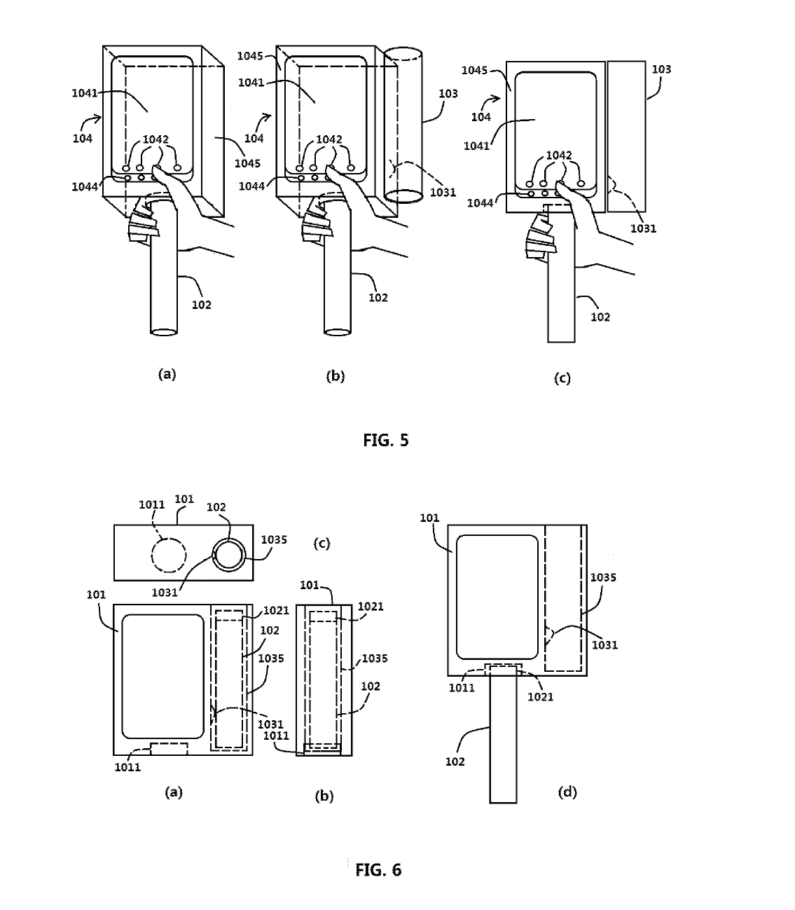

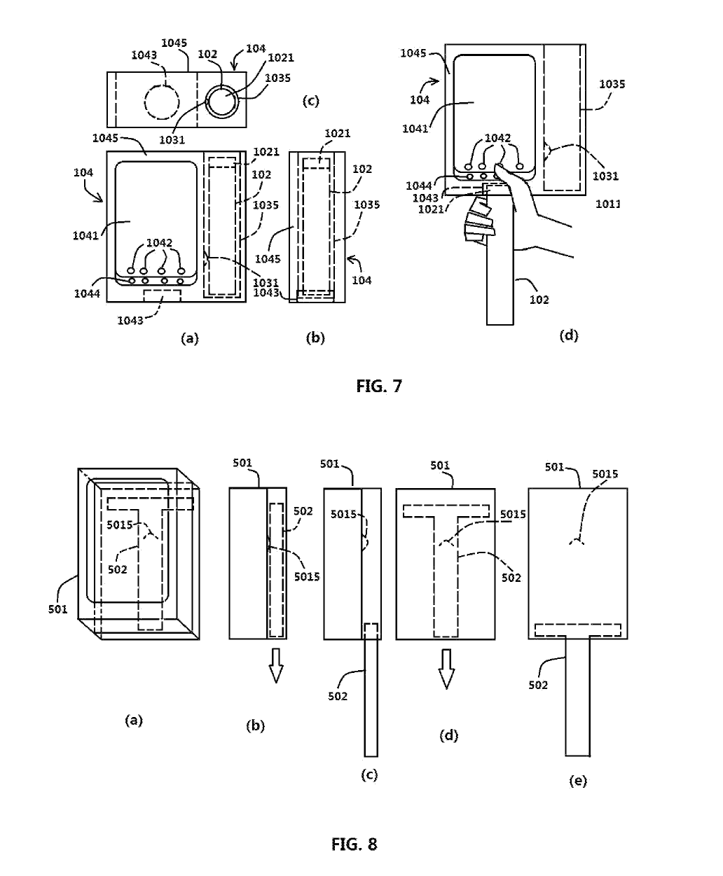

The inventive smartphone protective case 101 discussed in the embodiments of FIG. 1, FIG. 2, FIG. 6 and FIG. 21 can be a housing of a smartphone as shown in FIG. 4, FIG. 5, FIG. 7 and FIG. 22. FIG. 4(a) has shown an embodiment of a housing 1045 of a smartphone 104 having the first connector 1043 at a lower location of the housing 1045, a touchscreen 1041 and a plurality of camera and/or video associated icons 1042 and/or a plurality of routine function keys 1044 shown on the touchscreen 1041. FIG. 4(b) has shown the handle container 103 fixed to the housing 1045 of the smartphone 104. FIG. 4(c) is the front view of FIG. 4(b). FIG. 5(a) has shown FIG. 4(a) with the handle 102 fixed with the housing 1045. FIG. 5(b) has shown FIG. 4(b) with the handle 102 being pulled out of the handle container 103 to be fixed with the housing 1045. FIG. 5(c) is the front view of FIG. 5(b). FIG. 7 has shown a housing 1045 of a smartphone 104 having the first connector 1043, a space 1035 for storaging the handle 102 formed in the housing 1045, and a touchscreen 1041 and a plurality of camera and/or video associated icons 1042 and/or a plurality of routine function keys 1044 shown on the touchscreen 1041.

FIG. 7(a), FIG. 7(b) and FIG. 7(c) are respectively a front view, a side view, and a top view of the housing 1045 of the smartphone 104 having the space 1035. FIG. 7(d) has shown FIG. 7(a) with the handle 102 pulled or slided out of the space 1035 in the housing 1045 to be fixed with the housing 1045 of the smartphone 104.

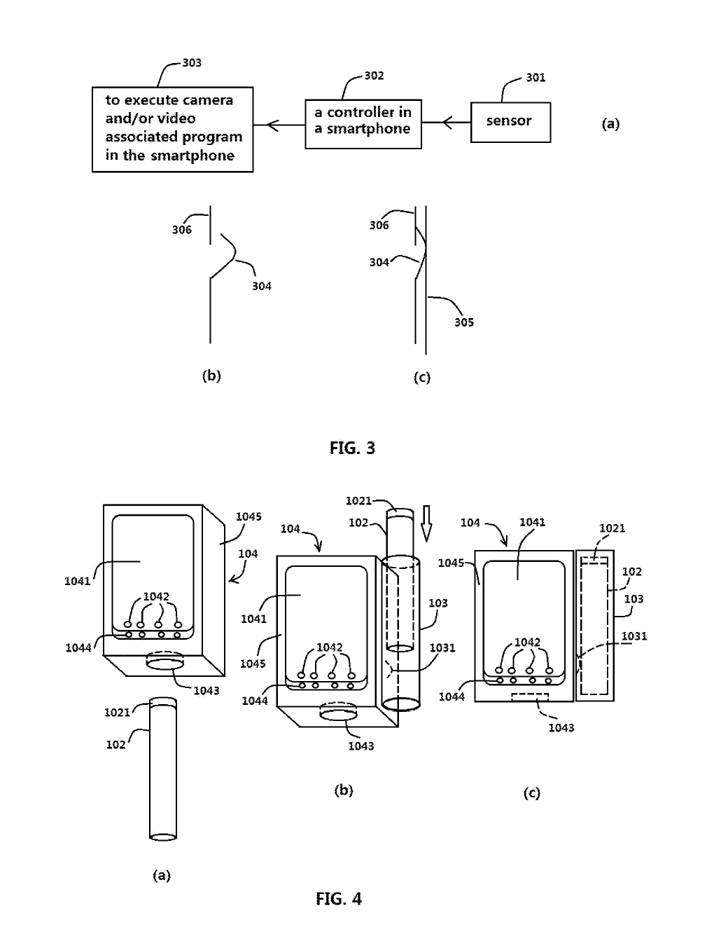

Before going further, a sensor is introduced in FIG. 3. Seeing a flow chart shown in FIG. 3(a), if a sensor 301 is triggered and sensed by a controller 302 in a smartphone, then the controller 302 immediately executes the camera and/or video associated programs in the smartphone, for example, the programs bring the smartphone into the camera and/or the video mode with associated camera and/or the video icons appeared in the touchscreen ready to take command from user. The sensor 301 is not limited, for example, the sensor 301 can be a switch 304 as shown in an embodiment of FIG. 3(b). FIG. 3(b) has shown a switch 304 and a terminal 306 are in an open state and when a body 305 presses the switch 304 causing the switch 304 to electrically touch the terminal 306 to change the open state into a short state. The state change can be detected by the controller 302 to executes the camera and/or video associated programs in the smartphone to get the smartphone into the camera and/or the video mode as indicated by the flow chart of FIG. 3(a). The switch 304 can go through an input/output port built on the housing of the smartphone to electrically connect the controller in the smartphone or the switch 304 can directly electrically connect to the controller in the smartphone. The sensor is not limited to any particular sensor in the present invention although the switch will be used in all the embodiments in the present invention.

A switch 1031 is fixed inside the handle container 103 as seen in FIG. 1(b), FIG. 1(c), FIG. 2(b), FIG. 2(c), FIG. 4(b), FIG. 4(c), FIG. 5(b), FIG. 5(c), FIG. 6(a), FIG. 6(c), FIG. 6(d), FIG. 7(a), FIG. 7(c), FIG. 7(d), is fixed to the smartphone protective case 101 as seen in FIG. 21(b), and is fixed to the housing 1045 of the smartphone 104 as seen in FIG. 22(b). The switch 1031 is in a first state when the handle 102 is inside the handle container 103 or the handle 102 is held by the clamp 1088 and the switch 1031 is in a second state when the handle 102 is taken out of the handle container 103 or is taken off the clamp 1088. The state change of the switch 1031 will immediately execute the camera and/or video associated programs in the smartphone to bring the smartphone into the camera and/or the video mode with associated icons shown in the touchscreen ready to take command from user.

The embodiments of FIGS. 1, 2, 3, 4, 5, 6, 7, 21 and 22 have respectively advantaged: (1) user can take picture or shoot a film by using only one hand, (2) user can lower the chances of mistouching the sensitive touchscreen while operating the smartphone, (3) by operating the handle can get the smartphone into camera and video mode, and (4) user can quickly respond to take a transient picture or shoot a transient video.

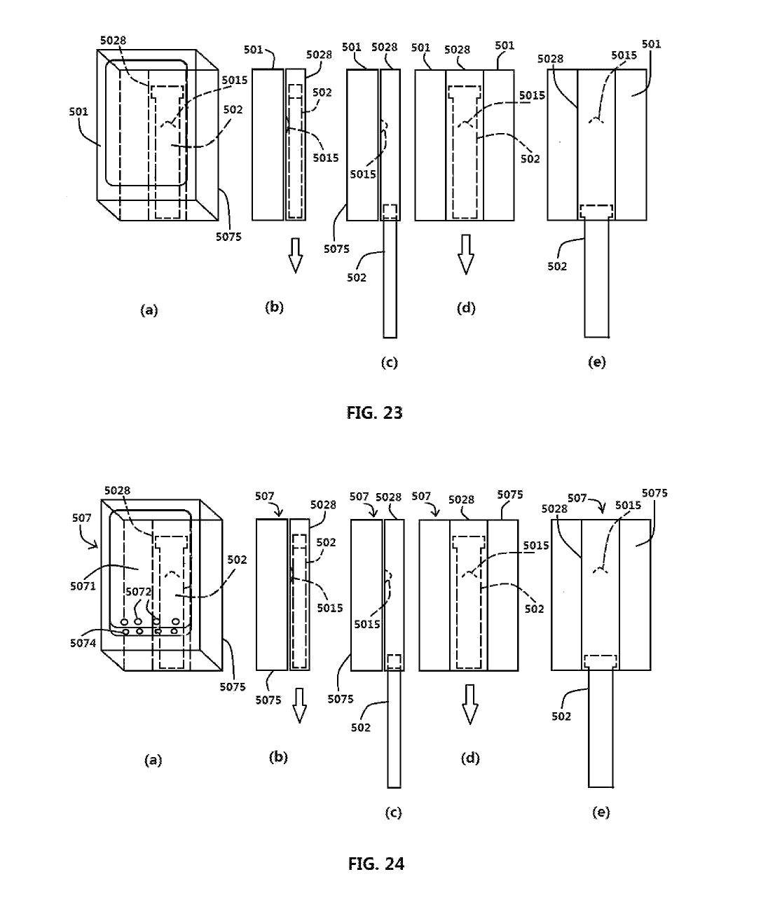

A handle can be disposed in a space formed inside a smartphone protective case as shown in FIG. 8 or disposed in a handle container fixed to a smartphone protective case as shown in FIG. 23 and the handle can slide in and out.

FIG. 8 has shown an embodiment of a handle 502 disposed in a space formed inside the smartphone protective case 501 and the handle 502 can be confinedly slided in the space. FIG. 8(b) and FIG. 8(d) are respectively a side view and a back view of the smartphone protective case 501 of FIG. 8(a). The handle 502 can be confinedly pulled or slided out of the smartphone protective case 501 toward its bottom direction respectively as shown in FIG. 8(c) and FIG. 8(e), which are respectively FIG. 8(b) and FIG. 8(d) with the handle 502 being pulled or slided out. The handle 502 is pulled out of the smartphone protective case 501 to expose a portion of the handle 502 with a suitable size and shape comfortably firmly held by hand. The pulled out handle 502 can be pushed or slided back into the smartphone protective case 501 for storage. The embodiment of FIG. 8 has shown the exposed portion of the handle 502 is centered at the bottom of the smartphone protective case 501 although the present invention is not so limited.

FIG. 23 has shown an embodiment of a handle 502 disposed in a handle container 5028 fixed to a smartphone protective case 501. FIG. 23(b) and FIG. 23(d) are respectively a side view and a back view of the smartphone protective case 501 of FIG. 23(a). The handle 502 can be confinedly pulled or slided out of the handle container 5028 fixed to the smartphone protective case 501 toward its bottom direction respectively as shown in FIG. 23(c) and FIG. 23(e), which are respectively FIG. 23(b) and FIG. 23(d) with the handle 502 being pulled or slided out. The handle 502 is pulled out of the handle container 5028 to expose a portion of the handle 502 with a suitable size and shape comfortably firmly held by hand and a plurality of camera and/or video associated icons 5072 and/or a plurality of routine function keys 5074 shown on the touchscreen 5071 are touchable by thumb by the hand holding the handle 502.

The pulled out handle 502 can be pushed or slided back into the handle container 5028 for storage. The embodiment of FIG. 23 has shown the exposed portion of the handle 502 is centered at the bottom of the smartphone protective 501 although the present invention is not so limited.

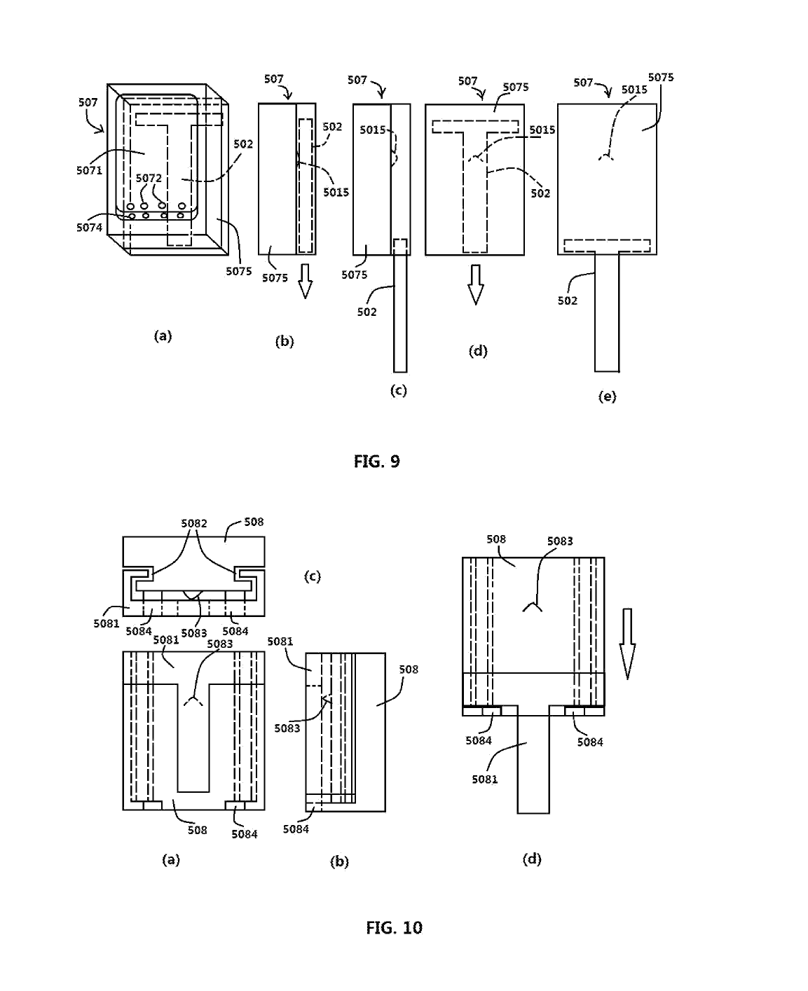

A handle can be disposed in a space formed inside a housing of a smartphone as shown in FIG. 9 or disposed in a handle container fixed to a housing of a smartphone as shown in FIG. 24 and the handle can slide in and out.

FIG. 9 has shown an embodiment of a handle 502 disposed in a space formed inside a housing 5075 of a smartphone 507 and the handle 502 can be confinedly slided in the space. FIG. 9(b) and FIG. 9(d) are respectively a side view and a back view of the housing 5075 of the smartphone 507 of FIG. 9(a). The handle 502 can be confinedly pulled or slided out of the housing 5075 of the smartphone 507 toward its bottom direction respectively as shown in FIG. 9(c) and FIG. 9(e), which are respectively FIG. 9(b) and FIG. 9(d) with the handle 502 being pulled or slided out. The handle 502 is pulled out of the housing 5075 smartphone to expose a portion of the handle 502 with a suitable size and shape comfortably firmly held by hand. The pulled out handle 502 can be pushed or slided back into the housing 5075 for storage. The embodiment of FIG. 9 has shown the exposed portion of the handle 502 is centered at the bottom of the smartphone protective case 501 although the present invention is not so limited.

FIG. 24 has shown an embodiment of a handle 502 disposed in a handle container 5028 fixed to a housing 5075 of a smartphone 507. FIG. 24(b) and FIG. 24(d) are respectively a side view and a back view of the housing 5075 of the smartphone 507 of FIG. 24(a). The handle 502 can be confinedly pulled or slided out of the handle container 5028 fixed to the housing 5075 of the smartphone 507 toward its bottom direction respectively as shown in FIG. 24(c) and FIG. 24(e), which are respectively FIG. 24(b) and FIG. 24(d) with the handle 502 being pulled or slided out. The handle 502 is pulled out of the handle container 5028 to expose a portion of the handle 502 with a suitable size and shape comfortably firmly held by hand and a plurality of camera and/or video associated icons 5072 and/or a plurality of routine function keys 5074 shown on the touchscreen 5071 are touchable by thumb by the hand holding the handle 502.

The pulled out handle 502 can be pushed or slided back into the handle container 5028 for storage. The embodiment of FIG. 23 has shown the exposed portion of the handle 502 is centered at the bottom of the smartphone protective 501 although the present invention is not so limited.

A handle can be held by and slided in parallel to the back of a smartphone protective case or a housing of a smartphone as shown in an embodiment of FIG. 10. The embodiments of FIG. 10(a), FIG. 10(b) and FIG. 10(c) are respectively a front view, a side view, and a top view of a back 508 of a housing of a smartphone or a smartphone protective case. FIG. 10(c) has shown the back 508 has two grooves 5082 respectively at two side ends and a handle 5081 in parallel to the back 508 has two U-shaped sides to couple the two grooves so the handle 5081 can be held by the back 508 sliding in parallel to the back 508. The housing also has stoppers 5084 to stop the sliding handle 5081 no moving further so the handle 5081 can only slide back and forth within a distance. Seen in FIG. 10(c), the handle 5081 slides in perpendicular to the paper plane. A switch 5083 is disposed between the handle 5081 and the back 508 at a first state and the switch 5083 changes to a second state when the handle 5081 slides. The state change will be sensed by a controller of the smartphone to executes the camera and/or video associated programs in the smartphone to bring the smartphone into the camera and/or the video mode with associated icons shown in the touchscreen as indicated by the flow chart of FIG. 3(a). FIG. 10(d) is FIG. 10(a) with the handle 5081 slided out so that at least a portion of the handle 5081 with a suitable size and shape can be comfortably firmly held by hand. The handle 5081 can be slided back and forth in parallel to the back 508.

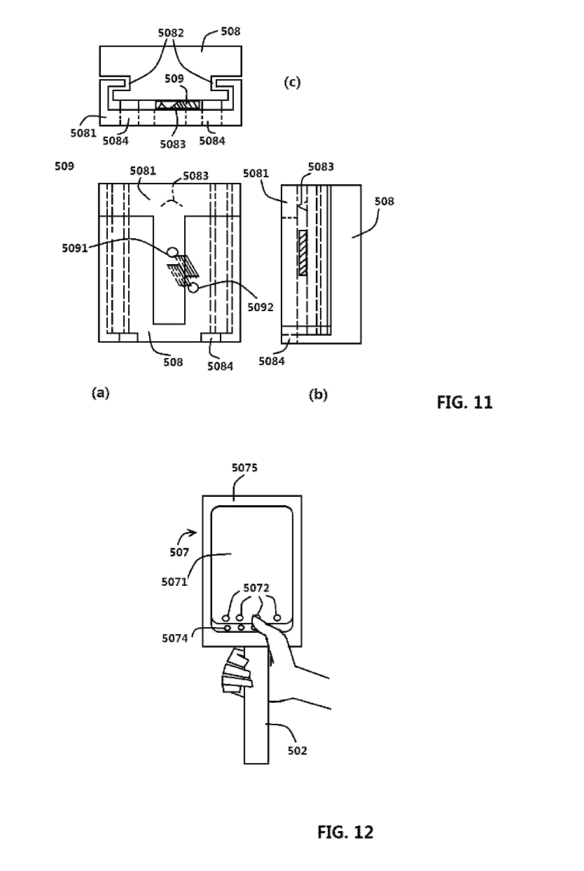

FIG. 11 has copied FIG. 10 with a sliding-spring element 509 disposed between the handle 5081 and the back 508 with one end of the sliding-spring element 509 connecting to the back 508 through a first rotating element 5092 and the other end of the sliding-spring element 509 connecting to the handle 5081 through a second rotating element 5091. When the handle 5081 slides, the first rotating element 5092 and the second rotating element 5092 rotate and the springs in the sliding-spring element 509 slide in the sliding-spring element 509 to help the smooth sliding of the handle 5081. The sliding-spring element 509 can be seen in sliding mobile phone. The sliding-spring element 509 is not limited to any particular sliding-spring element in the present invention.

The slided out handle 5081 can be conveniently and firmly held by hand as shown in FIG. 12, which is a front view of the smartphone of FIG. 10(a) and FIG. 11(a) with the handle slided out. FIG. 12 has also shown a plurality of camera and/or video associated icons 5072 and/or a plurality of routine function keys 5074 shown on the touchscreen 1041 reachable or touchable by the thumb of a hand holding the handle 502.

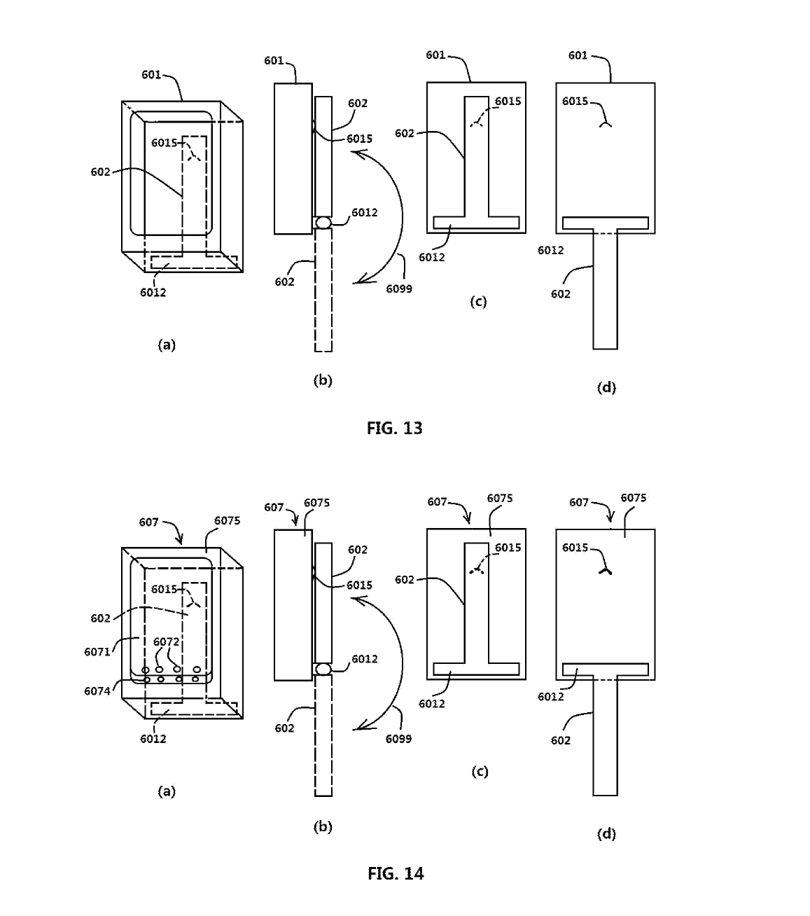

FIG. 13 has shown an embodiment of a smartphone protective case 601 having a handle 602 with a suitable size and shape for being comfortably firmly held by hand connected to a rotational element 6012 fixed to the back of a smartphone protective case 601. FIG. 13(b) and FIG. 13(c) are respectively a side view and a back view of the smartphone protective case 601 of FIG. 13(a). The handle 602 can make a rotational movement around the rotational element 6012 to rotate in parallel to the paper plane back and forth as indicated by an arrow 6099 shown in FIG. 13(b). FIG. 13(d) is FIG. 13(c) with the handle 602 rotated in perpendicular to the paper plane to stick out the handle 602 toward the bottom side of the smartphone protective case. At least a portion of the handle 602 sticks out of the bottom edge of the smartphone protective case 601 to be comfortably firmly held by hand. The location of the rotational element 6012 on the back of the smartphone protective case 601 is not limited as long as the stuck out portion of the handle is long enough to be firmly held. The rotational element 6012 is located at the bottom edge of the smartphone protective case 601 in the embodiment of FIG. 13 although the present invention is not so limited.

The smartphone protective case 601 discussed in the embodiments of FIG. 13 can be a housing of a smartphone as shown in FIG. 14. FIG. 14(a) has shown a housing 6075 of a smartphone 607 in 3-dimension having the handle 602 connected to the rotational element 6012 fixed to the back of the housing 6075 of the smartphone 607.

FIG. 14(b) and FIG. 14(c) are respectively a side view and a back view of the smartphone of FIG. 14(a). The handle 602 can make a rotational movement around the rotational element 6012 to rotate in parallel to the paper plane back and forth as indicated by the arrow 6099 shown in FIG. 14(b). FIG. 14(d) is FIG. 14(c) with the handle 602 rotated in perpendicular to the paper plane to stick out the handle 602 suitably for being held by hand. The rotational element 6012 is located at the bottom edge of the housing 6075 of the smartphone 607 in the embodiment of FIG. 14 although the present invention is not so limited.

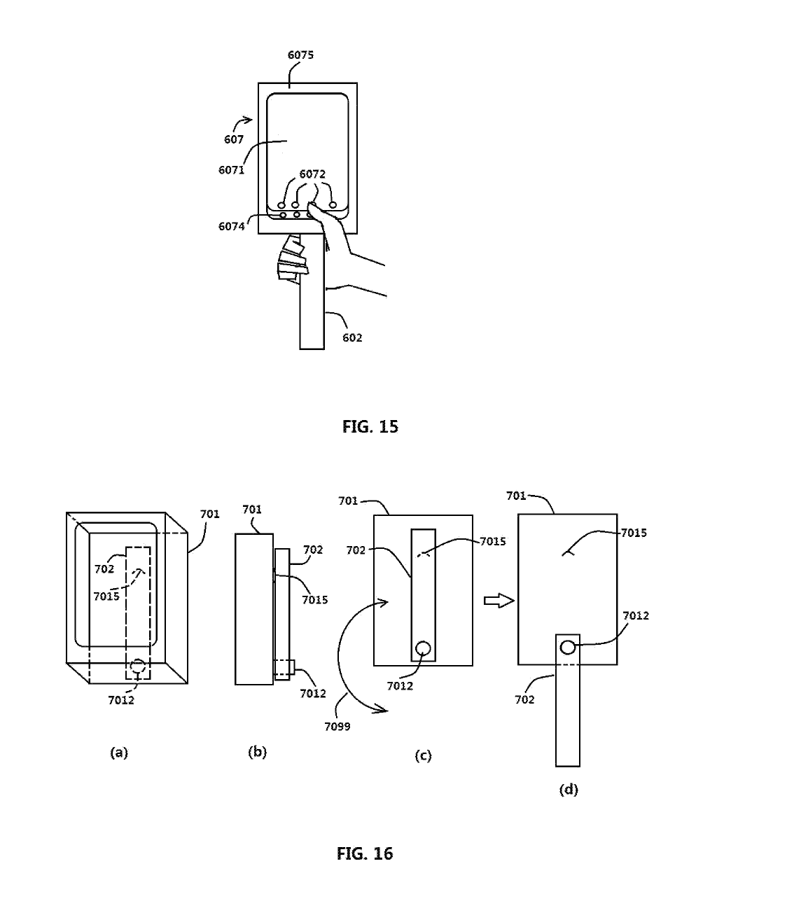

A switch 6015 electrically connected to a controller of the smartphone is fixed to the back of the smartphone protective case 601 under the handle 602 as shown in FIG. 13 or is fixed to the housing 6075 of the smartphone 607 under the handle 602 as shown in FIG. 14. When the handle 602 is rotated, the state of the switch 6015 changes to inform the controller of the smartphone. FIG. 15 is a front view of the embodiment of the smartphone of FIG. 14(d) with a plurality of camera and/or video associated icons 6072 and/or a plurality of routine function keys 6074 shown on a touchscreen 6071 of the smartphone reachable or touchable by the thumb of hand holding the handle 602 so the thumb can touch the icons to operate the ions.

FIG. 16 has shown an embodiment of a smartphone protective case 701 having a handle 702 with a suitable size and shape for being comfortably firmly held by hand connected to a rotational element 7012 fixed on the back of a smartphone protective case 701. FIG. 16(b) and FIG. 16(c) are respectively a side view and a back view of the smartphone protective case 701 of FIG. 16(a). The handle 702 can make a rotational movement around the rotational element 7012 to rotate in parallel to the paper plane back and forth as indicated by an arrow 7099 shown in FIG. 16(c). FIG. 16(d) is FIG. 16(c) with the handle 702 rotated to a location perpendicular to the bottom edge of the smartphone protective case 701 ready for being held by hand although the present invention is not so limited.

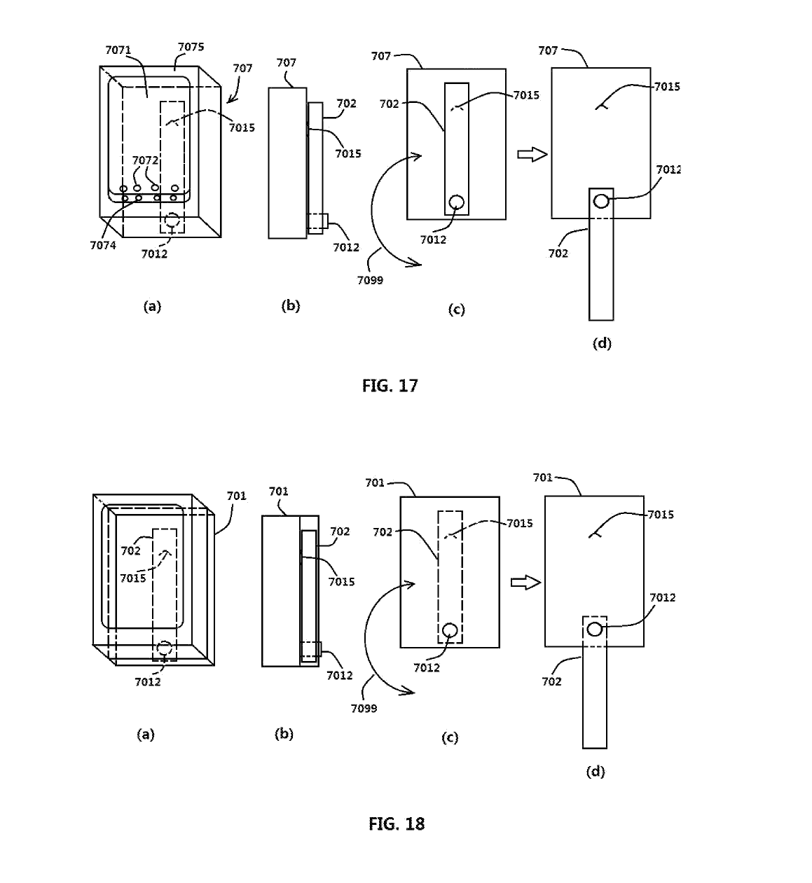

The smartphone protective case 701 discussed in the embodiments of FIG. 16 can be a housing of a smartphone as shown in FIG. 17. FIG. 17(a) has shown a housing 7075 of a smartphone 707 in 3-dimension having the handle 702 connected to the rotational element 7012 fixed on the back of the housing 7075 of the smartphone 707.

FIG. 17(b) and FIG. 17(c) are respectively a side view and a back view of the smartphone of FIG. 17(a). The handle 702 can make a rotational movement around the rotational element 7012 to rotate in parallel to the paper plane back and forth as indicated by an arrow 7099 shown in FIG. 17(c). FIG. 17(d) is FIG. 17(c) with the handle 702 rotated to a location perpendicular to the bottom edge of the housing 7075 of the smartphone 707 ready for being held by hand although the present invention is not so limited.

A switch 7015 is fixed to the back of the smartphone protective case 701 shown in FIG. 16 under the handle 702 or the housing 6075 of the smartphone 607 under the handle 702 as shown in FIG. 17. When the handle 702 is rotated, the state of the switch 7015 changes to inform the controller of the smartphone.

FIG. 18(a) has shown an embodiment of a smartphone protective case 701 in 3-dimension having a handle 702 with a suitable size and shape for being comfortably firmly held by hand disposed in a smartphone protective case 701 with at least one opening on its side and connected to a rotational element 7012 fixed on a smartphone protective case 701. FIG. 18(b) and FIG. 18(c) are respectively a side view and a back view of the smartphone protective case 701 of FIG. 18(a). The handle 702 can make a rotational movement around the rotational element 7012 to rotate in parallel to the paper plane back and forth out of the opening on its side as indicated by an arrow 7099 shown in FIG. 18(c). FIG. 18(d) is FIG. 18(c) with the handle 702 rotated to a location perpendicular to the bottom edge of the smartphone protective case 701 ready for being held by hand although the present invention is not so limited.

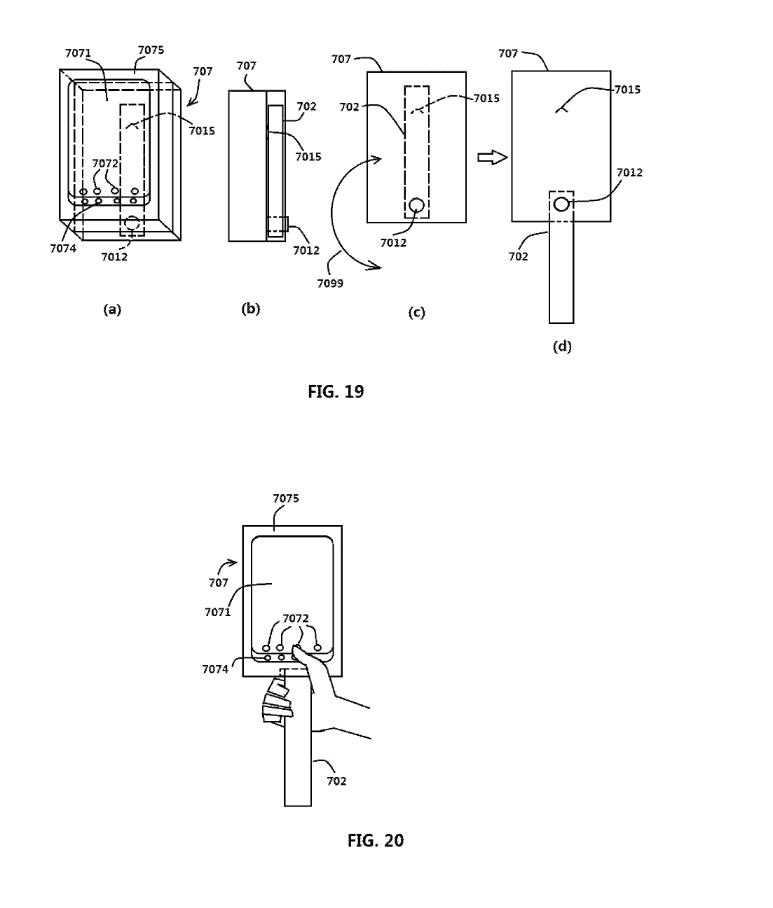

The smartphone protective case 701 discussed in the embodiments of FIG. 19 can be a housing of a smartphone as shown in FIG. 19. FIG. 19(a) has shown a housing 7075 of a smartphone 707 in 3-dimension having the handle 702 disposed in the housing 7075 of the smartphone 707 with at least one opening on its side and connected to a rotational element 7012 fixed to the housing 7075 of the smartphone 707.

FIG. 19(b) and FIG. 19(c) are respectively a side view and a back view of the housing 7075 of the smartphone 707 of FIG. 19(a). The handle 702 can make a rotational movement around the rotational element 7012 to rotate in parallel to the paper plane back and forth out of the opening on its side as indicated by an arrow 7099 shown in FIG. 19(c). FIG. 19(d) is FIG. 19(c) with the handle 702 rotated to a location perpendicular to the bottom edge of the housing 7075 of the smartphone 707 ready for being held by hand although the present invention is not so limited.

A switch 7015 is fixed to the smartphone protective case 701 shown in FIG. 18 under the handle 702 or the housing 7075 of the smartphone 707 under the handle 702 as shown in FIG. 19. When the handle 702 is rotated, the state of the switch 7015 changes to inform the controller of the smartphone.

FIG. 20 is a front view of the embodiment of the smartphone of FIG. 16(d) with a smartphone disposed into the smartphone protective case, FIG. 17(d), FIG. 18(d) with a smartphone disposed into the smartphone protective case, and FIG. 19(d) with a plurality of camera and/or video associated icons 7072 and/or a plurality of routine function keys 7074 shown on a touchscreen 7071 of the smartphone reachable or touchable by the thumb of hand holding the handle 702 so the thumb can touch the icons to operate the ions.

The embodiments shown in the present invention have respectively advantaged: (1) user can take picture or shoot a film by using only one hand, (2) user can lower the chances of mistouching the sensitive touchscreen while operating the smartphone, (3) by operating the handle can get the smartphone into camera and video mode, and (4) user can quickly respond to take a picture or shoot a video.

The handle of each of all the embodiments in the present invention is stuck out from and centered at the bottom edge of the smartphone or the smartphone protective case although the present invention is not so limited. The handle is located so that the camera and/or video icons shown on the touchscreen are reachable by the thumb of the hand holding the handle.

The handle mentioned in the present invention can be made of a light-weight material with strength enough to hold the weight of the smartphone, an embodiment, the handle can be made of a metal or a plastic material.

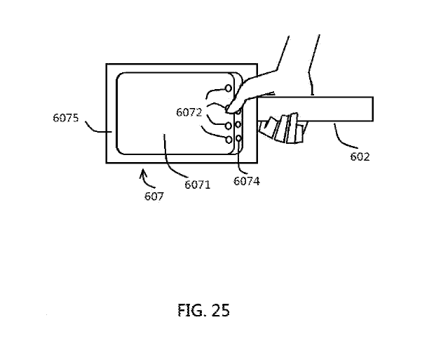

FIG. 25 is FIG. 15 demonstrating the smartphone 607 disposed in horizontal position to take a picture or shoot a video film to show its convenience.

When the handle is rotated, slided, or fixed to a location to be held by hand of user the lens and flash light usually disposed on the rear housing of the smartphone can be exposed without being obstructed by the handle.

1. A smartphone, comprising:
a housing; and
a handle connected with the housing with at least a portion of the handle sticking out of the edge of the housing to be held by hand;
wherein the portion of the handle sticking out from the edge of the housing provides the housing more space for user to hold so that the smartphone can be more firmly held by user and icons on the smartphone can be more conveniently operated.

2. The smartphone of claim 1, wherein a plurality of camera and video associated icons shown on a touchscreen of the smartphone are touchable by a thumb of the hand holding the handle.

3. The smartphone of claim 2, wherein the handle and the housing are separable, and the handle separated from the housing is disposed in a space formed inside the housing.

4. The smartphone of claim 2, wherein the handle and the housing are separable, and the handle separated from the housing is held by a clamp fixed to the housing.

5. The smartphone of claim 2, wherein the handle is fixed to a rotational element and the rotation element is fixed to the housing, the handle makes rotational movement around the rotation element to a first location where the handle is suitably held by the hand of the user and the handle makes rotational movement around the rotation element to a second location where the handle stays.

6. The smartphone of claim 2, wherein the handle and the housing are separable, and the handle separated from the housing is disposed into a handle container fixed to the housing.

7. The smartphone of claim 2, wherein the handle is held by a back of the housing, and the handle slides in parallel to the back of the housing from a first location to a second location where the handle is suitably held by the hand of the user and the handle slides back to the first location where the handle stays.

8. The smartphone of claim 6, further comprising a switch disposed inside the handle container and electrically connected to a controller of the smartphone, wherein the handle is taken out of the handle container changing the state of the switch, the state change of the switch informs the controller to bring the smartphone into camera and video mode with associated camera and video icons shown on the smartphone.

9. The smartphone of claim 5, further comprising a switch electrically connected to a controller of the smartphone and fixed to the housing, wherein the handle is rotated around the rotational element changing the state of the switch, the state change of the switch informs the controller to bring the smartphone into camera and video mode with associated camera and video icons shown on the smartphone.

10. The smartphone of claim 4, further comprising a switch electrically connected to a controller of the smartphone and fixed on the housing, wherein the handle is taken off the clamp changing the state of the switch, the state change of the switch informs the controller to bring the smartphone into camera and video mode with associated camera and video icons shown on the smartphone.

11. The smartphone of claim 3, further comprising a switch electrically connected to a controller of the smartphone and disposed inside the space formed inside the housing, wherein the handle is taken out of the space changing the state of the switch, the state change of the switch informs the controller to bring the smartphone into camera and video mode with associated camera and video icons shown on the smartphone.

12. The smartphone of claim 7, further comprising a switch fixed on the back of the housing and electrically connected to a controller of the smartphone, wherein the handle slides changing the state of the switch, the state change of the switch informs the controller to bring the smartphone into camera and video mode with associated camera and video icons shown on the smartphone.

13. The smartphone of claim 12, further comprising a sliding-spring element disposed between the handle and the housing, a first rotation element connected to a first end of sliding-spring element and the housing, and a second rotation element connected to a second end of sliding-spring element and the handle for helping the smooth sliding of the handle on the back of the housing.

14. The smartphone of claim 7, further comprising a sliding-spring element disposed between the handle and the housing, a first rotation element connected to a first end of sliding-spring element and the housing, and a second rotation element connected to a second end of sliding-spring element and the handle for helping the smooth sliding of the handle on the back of the housing.

15. The smartphone of claim 1, further comprising a switch electrically connected to a controller of the smartphone and disposed inside the space formed inside the housing, wherein the handle and the housing are separable, and the handle separated from the housing is disposed in the space formed inside the housing, the handle is taken out of the space changing the state of the switch, the state change of the switch informs the controller to bring the smartphone into camera and video mode with associated camera and video icons shown on the smartphone.

16. The smartphone of claim 1, further comprising a switch electrically connected to a controller of the smartphone and fixed on the housing, wherein the handle and the housing are separable, and the handle separated from the housing is held by a clamp fixed to the housing the handle is taken off the clamp changing the state of the switch, the state change of the switch informs the controller to bring the smartphone into camera and video mode with associated camera and video icons shown on the smartphone.

17. The smartphone of claim 1, further comprising a switch electrically connected to a controller of the smartphone and fixed to the housing, wherein the handle is fixed to a rotation element and the rotation element is fixed to the housing, the handle makes rotational movement around the rotational element to a first location where the handle is suitably held by the hand of the user and the handle makes rotational movement around the rotation element to a second location where the handle stays, the handle is rotated around the rotation element from the second location to the first location changing the state of the switch, the state change of the switch informs the controller to bring the smartphone into camera and video mode with associated camera and video icons shown on the smartphone.

18. The smartphone of claim 1, further comprising a switch disposed inside the handle container and electrically connected to a controller of the smartphone, wherein the handle and the housing are separable, and the handle separated from the housing is disposed into a handle container fixed to the housing, the handle is taken out of the handle container changing the state of the switch, the state change of the switch informs the controller to bring the smartphone into camera and video mode with associated camera and video icons shown on the smartphone.

19. The smartphone of claim 1, further comprising a switch fixed on the back of the housing and electrically connected to a controller of the smartphone, wherein the handle is held by a back of the housing, and the handle slides in parallel to the back of the housing from a first location to a second location where the handle is suitably held by the hand of the user and the handle slides back to the first location where the handle stays, the handle slides from the first location to the second location changing the state of the switch, the state change of the switch informs the controller to bring the smartphone into camera and video mode with associated camera and video icons shown on the smartphone.
